(19) United States
(12) Patent Application Publication
(10) Pub. No.: US 2006/0044646 A1
(43) Pub. Date: Mar. 2, 2006

(54) Optical amplification device, raman amplifier, optical wavelength-division multiplex transmission system and optical wavelength-division multiplex transmission method

(75) Inventor: Yoshihiro Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/995,277

(22) Filed: Nov. 24, 2004

(30) Foreign Application Priority Data
Aug. 26, 2004 (JP) 2004-246864

(51) Int. Cl. H01S 3/00

(52) U.S. Cl. 359/337.4

(57) ABSTRACT

The optical amplification device disposed in an optical transmission line for transmitting a plurality of segments of signal light each with a different wavelength comprises a first optical amplifier disposed in the optical transmission line, an optical power monitor unit provided in the down stream of the first optical amplifier in order to control the first optical amplifier, and a second optical amplifier, disposed between the first optical amplifier and the optical power monitor unit, capable of variably controlling the amplification band and absorption band of light.

### BACKGROUND OF THE INVENTION

1. Field of the Invention

The present invention relates to an optical amplification device, a Raman amplifier, an optical wavelength-division multiplex transmission system and an optical wavelength-division multiplex transmission method, more particularly, to a technology effectively applied to an optical transmission technology for transmitting data for a long distance by applying wavelength-division multiplexing to signal light with a large number of wavelengths and the like.

2. Description of the Related Art

In the recent optical communication technology, a wavelength-division multiplexing technology for transmitting data for a long distance by applying wavelength-division multiplexing to a plurality of segments of signal light each with a different wavelength is widely used.

Conventionally, long-haul transmission has been realized by inputting excitation signal light with a wavelength approximately 100 m apart from a signal light wavelength toward a short wavelength side and combining a Raman amplifier for amplifying a plurality of segments of signal light in transmission with an erbium-doped fiber amplifier (EDFA) by non-linear effect (Raman effect) in a transmission line fiber in order to suppress the attenuation of signal light power due to the transmission line fiber and to realize long-haul transmission.

In the Raman amplifier, although the amount of amplified spontaneous Raman scattering (ASS) light generated in the transmission line fiber must be estimated based on the amount of output of excitation light monitored by an optical power monitor unit in order to perform control, such as total power control, the correction of amplified spontaneous emission (ASE) noise (noise light generated by combining a part of spontaneously emitted light with the basic mode of an optical fiber and further amplifying it by induced emission) due to EDFA, the detection of signal interruption and the like, the amount has been determined based on the measurement data of a specific fiber.

ASS is noise light generated by Raman amplification, and is generated by inputting only Raman excitation light to an amplification medium (transmission line fiber) in a state where no signal light is inputted. This is generally called “Raman scattered light” by pump light or the like.

In this case, even if the types of transmission line fibers are the same, the conditions (loss co-efficient, local loss, etc.) of a transmission line in initial measurement data are generally different from those of an actual transmission line. Therefore, in the case of a small number of wavelengths when only a part of signal light with the smaller number of wavelengths than that of rated wavelengths that can be multiplexed is used, sometimes the output control of an excitation LD is performed on a condition that the amount of generation of ASS light is not sufficiently small compared with a signal light level. Therefore, the detection accuracy of main signal interruption and the accuracy of total power control have been remarkably degraded.

Specifically, as shown in the left of FIG. 1, in the case of a large number of wavelengths, a ratio of the level of noise light (ASE+ASS) to the total level of signal light is small, and accordingly, a variety of control errors due to the level detection of signal light can be suppressed to a low level. However, in the case of a small number of wavelengths when only a part of signal light is used, as shown in the right of FIG. 1, a ratio of the level of noise light to the total level of signal light becomes large, and it becomes difficult to control errors by the level determination by threshold of signal light.

Thus, the amount of noise light, such as ASS and the like becomes larger than a threshold value for signal interruption detection, and the sensitivity of the signal interruption detection threshold value is low depending on operation conditions. Therefore, even when the input of signal light is interrupted by the disconnection of a transmission line fiber or the like, the amount of noise light does not drop below the threshold value, and accordingly, sometimes signal interruption can not be detected, and the automatic power shutdown of excitation light output could not function.

Patent Reference 1 discloses a technology for eliminating the noise of spontaneously emitted light by using an excessive saturation absorber made of a substance which absorbs input light with a prescribed optical intensity level or less and transmitting input light with the optical intensity level beyond the level as an optical filter. However, in this case, since an optical filter must be installed in addition to an amplifier, a structure becomes complex.

Patent Reference 2 discloses a technology for catching spontaneously emitted light which leaks outside from a rare earth-doped fiber by integrating sphere, detecting the integrated value by an optical detector and using the value for gain control in a rare earth-doped fiber amplifier. However, in Patent reference 2, the above-mentioned problem in the case where spontaneously emitted light and a plurality of segments of signal light are mixed is not recognized. Patent Reference 1: Japanese Patent Laid-open Application No. 11-168431 Patent Reference 2: Japanese Patent No. 2648643

### SUMMARY OF THE INVENTION

It is an object of the present invention to provide an amplification technology capable of accurately detecting the interruption of signal light, without being affected by the increase/decrease of the number of wavelengths to be used, in an optical transmission line for wavelength-division multiplex communication.

It is another object of the present invention to provide an amplification technology capable of precisely performing a variety of control, based on the level determination of signal light.

The first aspect of the present invention is an optical amplifier device disposed in an optical transmission line for transmitting a plurality of segments of signal light each with a different wavelength. The optical amplifier device comprises a first optical amplifier disposed in the optical transmission line, an optical power monitor unit provided in the under stream of the first optical amplifier, and a second optical amplifier disposed between the first optical amplifier and the optical power monitor unit, capable of variably controlling the amplification band and absorption band of light.

The second aspect of the present invention is a Raman amplifier disposed in an optical transmission line for transmitting a plurality of segments of signal light each with a different wavelength. The Raman amplifier comprises a semiconductor optical amplifier disposed between a multiplex unit for inputting excitation light to the optical transmission line and the optical power monitor unit provided in the down stream of the multiplex unit in order to control the Raman amplifier.

The third aspect of the present invention is an optical wavelength-division multiplex transmission system. The optical wavelength-division multiplex transmission system comprises an optical transmission line for transmitting signal light, a multiplexing unit for integrating the plurality of segments of signal light each with a different wavelength and inputting the signal light to the optical transmission line, a demultiplexing unit for demultiplexing and extracting the plurality of segments of signal light each with a different wavelength from the optical transmission line, and an optical amplification device provided in the optical transmission line, for amplifying the signal light. The optical amplification device comprises a first optical amplifier disposed in the optical transmission line, an optical power monitor unit provided in the down stream of the first optical amplifier, for controlling the first optical amplifier, a second optical amplifier disposed between the first optical amplifier and the optical power monitor unit, capable of variably controlling the amplification band and absorption band of light.

The fourth aspect of the present invention is an optical wavelength-division multiplex transmission method for disposing a Raman amplifier in an optical transmission line for transmitting a plurality of segments of signal light each with a different wavelength and for amplifying the signal light. The optical wavelength-division multiplex transmission method disposes a semiconductor optical amplifier between the multiplexing unit for inputting Raman excitation light to the optical transmission line and the optical power monitor unit, and absorbing light out of a band for the signal light to be used, by the semiconductor optical amplifier, according the increase/decrease of the number of the signal light to be used.

The fifth aspect of the present invention is a Raman amplifier. In the Raman amplifier, a semiconductor optical amplifier is disposed between a multiplexing unit for inputting Raman excitation light to an optical transmission line for transmitting a plurality of segments of signal light, and an optical power monitor unit and a rare earth-doped fiber amplifier.

According to the above-mentioned present invention, noise light in the wavelength range out of a band for signal light corresponding to the relevant number of wavelengths can be eliminated, according to the increase/decrease of the number of wavelengths to used. Therefore, if a wavelength-division multiplex communication is operated using a fairly small number of signal light, the fact that since signal light is buried in noise light, such as ASE, ASS or the like, the level of signal light cannot be determined by a threshold value, is surely avoided.

As a result, the interruption of signal light can be accurately detected without being affected by the increase/decrease of the number of wavelengths to be used.

### BRIEF DESCRIPTION OF THE DRAWINGS

FIG. 1 explains the problem of the conventional optical wavelength-division multiplex transmission system;

FIG. 2 shows one basic configuration of the optical amplification device in one preferred embodiment of the present invention;

FIG. 3 shows one basic configuration of an optical wavelength-division multiplex transmission system including the optical amplification device in one preferred embodiment of the present invention;

FIG. 4 is a basic section view showing one structure of the semiconductor optical amplifier constituting the optical amplification device in one preferred embodiment of the present invention;

FIG. 5 is a diagram showing the characteristic of the semiconductor optical amplifier constituting the optical amplification device in one preferred embodiment of the present invention;

FIG. 6 explains one example of the absorption of light noise by the semiconductor optical amplifier constituting the optical amplification device in one preferred embodiment of the present invention;

FIG. 7A explains one function in the case of a small number of wavelengths of the semiconductor optical amplifier constituting the optical amplification device in one preferred embodiment of the present invention;

FIG. 7B explains one example of the function in the case of a large number of wavelengths of the semiconductor optical amplifier constituting the optical amplification device in one preferred embodiment of the present invention;

FIG. 8 is a flowchart showing one example of the function of the optical amplification device in one preferred embodiment of the present invention;

FIG. 9 explains one example of the interruption detection function of the optical amplification device in one preferred embodiment of the present invention;

FIG. 10 shows the configuration of another optical amplification device in one preferred embodiment of the present invention;

FIG. 11 explains one example of the function of the semiconductor amplifier constituting another configuration of the optical amplification device in one preferred embodiment of the present invention;

FIG. 12 is a diagram showing one example of the function of the semiconductor amplifier constituting another configuration of the optical amplification device in one preferred embodiment of the present invention;

FIG. 13 is a flowchart showing one example of the function of the semiconductor amplifier constituting another configuration of the optical amplification device in one preferred embodiment of the present invention;

FIG. 14 is a section view showing one example of the semiconductor optical amplifier constituting another configuration of the optical amplification device in one preferred embodiment of the present invention;

FIG. 15 is a diagram showing one example of the function of the semiconductor optical amplifier constituting another configuration of the optical amplification device in one preferred embodiment of the present invention; and

FIG. 16 is a diagram showing one example of the function of the semiconductor optical amplifier constituting another configuration of the optical amplification device in one preferred embodiment of the present invention.

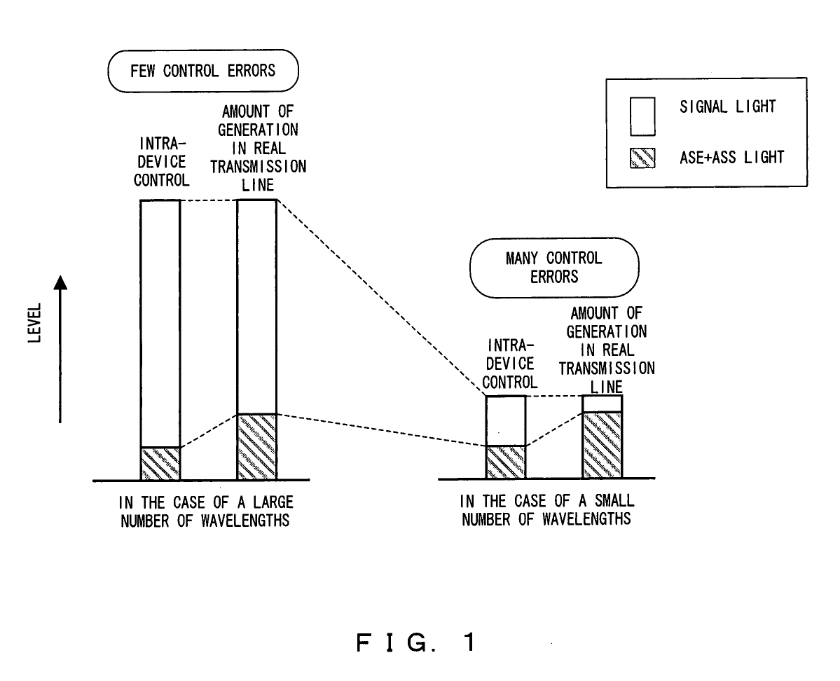

### DESCRIPTION OF THE PREFERRED EMBODIMENTS

The preferred embodiments of the present invention are described in detail below with reference to the drawings.

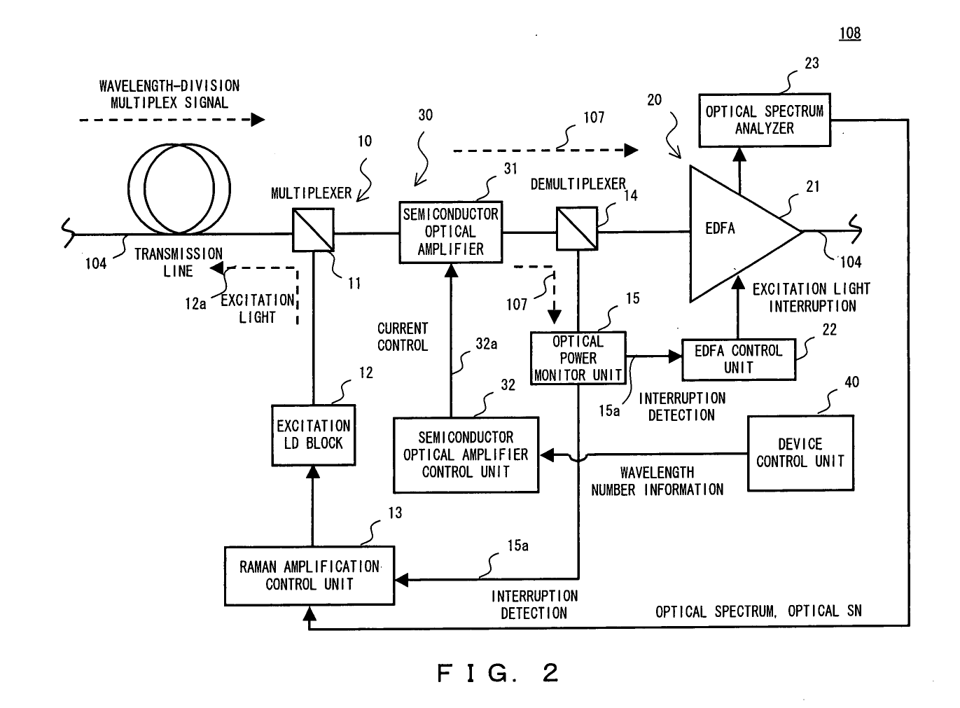

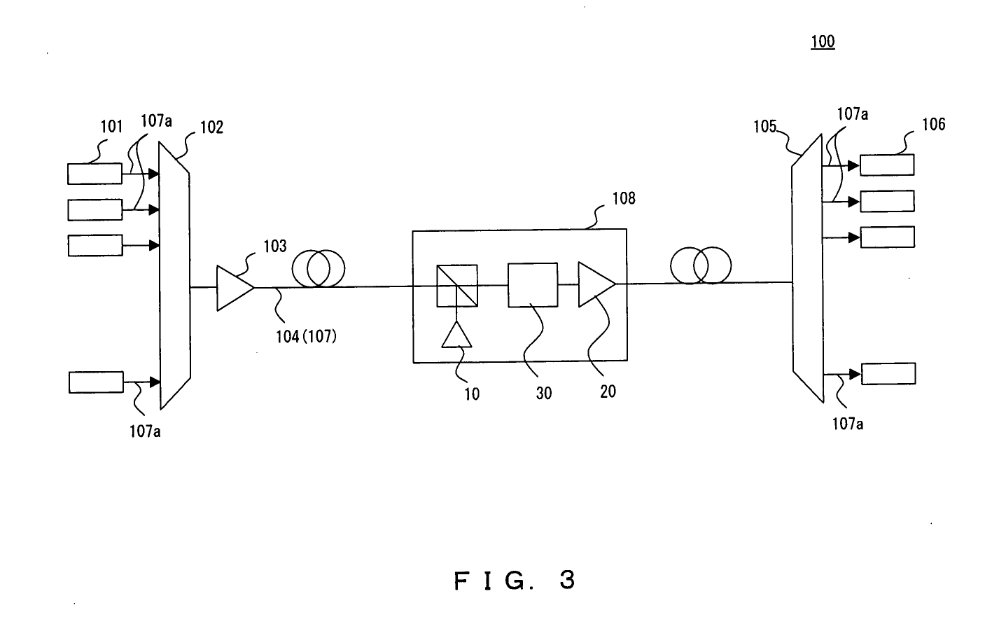

FIG. 2 shows one basic configuration of the optical amplification device in one preferred embodiment of the present invention. FIG. 3 shows one basic configuration of an optical wavelength-division multiplex transmission system including the optical amplification device in one preferred embodiment of the present invention.

As shown in FIG. 3, the optical wavelength-division multiplex transmission system 100 in this preferred embodiment comprises an electrical/optical converter 101 for converting an electrical signal containing transmission information into a plurality of optical signals 107a each with a different wavelength, an optical multiplexer 102 for multiplexing the plurality of optical signals 107a each with a different wavelength into wavelength-division multiplex signal light 107, an optical transmission line 104 composed of optical fibers for transmitting this wavelength-division multiplex signal light 107, a transmitting source amplifier 103 for amplifying the wavelength-division multiplex signal light 107 and transmitting the signal light to this optical transmission line 104, an optical demultiplexer 105, provided on the receiving side of the wavelength-division multiplex signal light 107, for demultiplexing and extracting the wavelength-division multiplex signal light 107 into the plurality of original optical signals 107a, and an optical /electrical converter 106 for converting each demultiplexed optical signal 107a into an electrical signal.

In the middle of the optical transmission line 104 for transmitting the wavelength-division multiplex signal light 107, one or more optical amplification devices 108 are provided to amplify the wavelength-division multiplex signal light 107 that is attenuated during transmission.

It is assumed that the maximum number of wavelengths (the number of optical signals 107a) to be multiplexed by the optical multiplexer 102 is K. In this case, for example, if band demand is small, sometimes only partial several wavelengths (S wavelengths) on the short wavelength side of the optical signals 107a are used (in the case of a small number of wavelengths) instead of using all K optical signals 107a.

In this case, since the respective amplification characteristics of a transmitting source amplifier 103 and an optical amplification device 108 provided in the optical transmission line 104 are set so as to amplify signals in a band covering all K optical signals 107a, noise light, such as ASE, ASS and the like, is generated in this broad band. Therefore, if only partial S wavelengths, of the K wavelengths are used, the amount of noise light becomes relatively large compared with the amount of the wavelength-division multiplex signal light 107, and accordingly, sometimes it becomes difficult to detect interruption, based on the level determination by threshold of the amount of the wavelength-division multiplex signal light 107.

Specifically, if the marginal number of wavelengths by which interruption can be detected without affected by noise light is assumed to be interruption detectable number of wavelengths m, in the case of S<m, it is difficult to detect interruption without any process. Therefore, in this preferred embodiment, this problem can be solved as follows.

As shown in FIG. 3, each optical amplification device 108 comprises a Raman amplifier 10 (first optical amplifier), and a device control unit 40 for controlling an EDFA unit 20 disposed after the Raman amplifier 10 and the entire system. Information, such as the maximum number of wavelengths K (number of optical signals 107a) to be multiplexed by the optical multiplexer 102, the actually used number of wavelengths S (number of optical signals 107a), the interruption detectable number of wavelengths m, being the marginal number of wavelengths by which interruption can be detected without affected by noise light and the like, are set in the device control unit 40.

The Raman amplifier 10 comprises a multiplexer 11 provided in the optical transmission line 104, an excitation light source (excitation LD block) 12 composed of laser diodes for transmitting excitation light 12a in the direction the reversal of the transmission direction of the wavelength-division multiplex signal light 107 in the optical transmission line 104 via this multiplexer 11, and the like, a Raman amplification control unit 13 for controlling this excitation light source 12, a demultiplexer 14 for demultiplexing and extracting a part of the wavelength-division multiplex signal light 107 from the optical transmission line 104, and an optical power monitor unit 15 for monitoring the amount of the wavelength-division multiplex signal light 107 demultiplexed by this demultiplexer 14 and outputting an interruption detection signal 15a both to the Raman amplification control unit 13 and an EDFA control unit 22, which is described later.

Then, by using an optical fiber constituting the optical transmission line 104 for transmitting the wavelength-division multiplex signal light 107, as an amplification medium, the wavelength-division multiplex signal light 107, including at least one optical signal 107a, can be amplified. Specifically, the Raman amplifier 10 of this preferred embodiment amplifies the wavelength-division multiplex signal light 107 which is attenuated during transmission, and restores the light up to a signal level which is in the dynamic range of the EDFA unit 20, which is described later.

The EDFA unit 20, for example, comprises an EDFA (erbium-doped fiber amplifier) 21 which uses an optical fiber doped in a specific rare earth element (for example, erbium), an EDFA control unit 22 for controlling the excitation light of this EDFA 21 or the like, and an optical spectrum analyzer 23 for outputting information, such as optical spectrum contained in the wavelength-division multiplex signal light 107 to be amplified, an optical SN ratio (ratio of signal light to ASS+ASE) and the like, to the Raman amplification control unit 13.

Then, if the optical power monitor unit 15 detects that the amount of the wavelength-division multiplex signal light 107 drops below a prescribed threshold value, it is determined, for example, that the optical transmission line is broken and disconnected for some reason, and an interruption detection signal 15a is outputted to both the Raman amplification control unit 13 and the EDFA control unit 22. In this case, the Raman amplification control unit 13 stops outputting excitation light 12a to the optical transmission line 104, and the EDFA control unit 22 stops outputting the excitation light 12a in the EDFA 21.

In the optical amplification device 108 with the above-mentioned configuration of this preferred embodiment, a semiconductor optical amplifier 30 (second optical amplifier) composed of a semiconductor optical amplifier unit 31 with a function to amplify/absorb light transmitted through the optical transmission line 104 and a semiconductor optical amplification control unit 32 for controlling this semiconductor optical amplifier unit 31 are provided between the multiplexer 11 and demultiplexer 14 of the Raman amplifier 10.

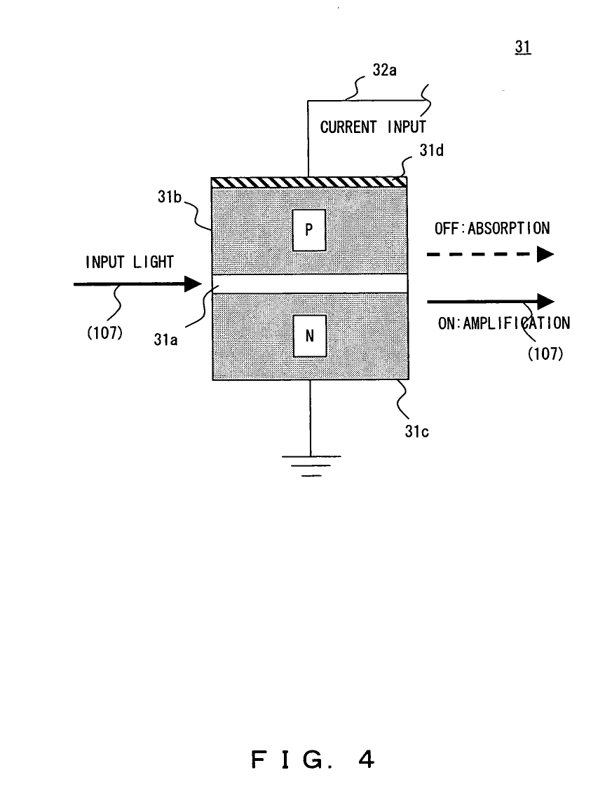

As shown in FIG. 4, the semiconductor optical amplifier unit 31, for example, comprises an active layer 31a made of a semiconductor, a P type semiconductor layer 31b and an N type semiconductor layer 31c which are disposed so as to pitch this active layer 31a, and an electrode 31d for inputting current.

Specifically, for this semiconductor optical amplifier unit 31, an InGaAsP double hetero type semiconductor laser diode on whose end surfaces (respective sections of the active layer 31a, P type semiconductor layer 31b and N type semiconductor layer 31c) a non-reflective film are coated and from which a mirror function is equivalently eliminated, can be used.

If current is not inputted (off) when light is inputted to the active layer 31a, an electron in a valence band absorbs light and transits to a conduction band (absorption). If light with energy equivalent to forbidden bandwidth passes in the neighborhood of the electron in the valence band, the electron transits to the valence band and also emits light whose frequency, phase and direction is the same as the input light (induced emission). In the semiconductor optical amplifier unit 31, PN junction can be formed, population inversion (state with high carrier density) can be generated by current input (on), and input light (the wavelength-division multiplex signal light 107) can be amplified (induced emission).

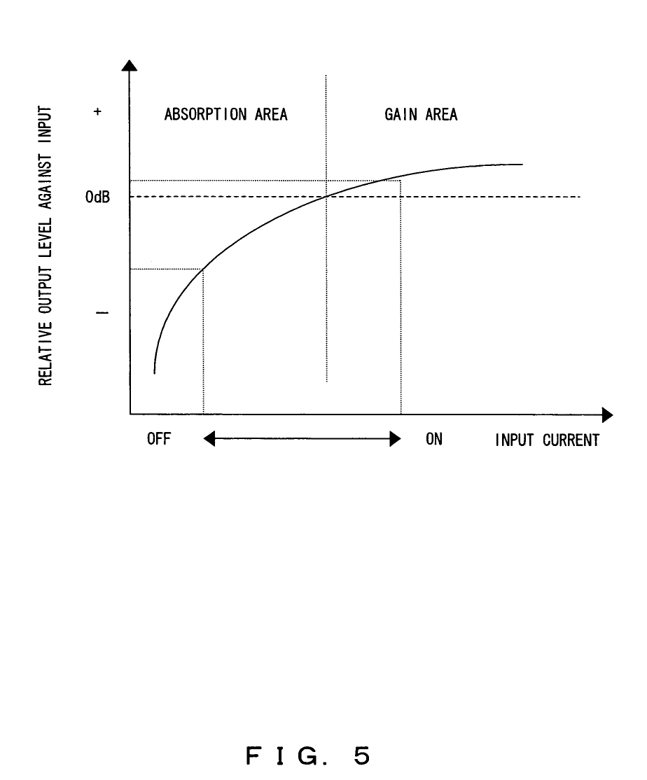

FIG. 5 is a diagram showing the characteristic of this semiconductor optical amplifier unit 31. The absorption and gain areas of the semiconductor optical amplifier unit 31 can be switched by the on/off of input current (a control current 32a).

Specifically, as shown in FIG. 5, when no current is inputted, the semiconductor optical amplifier unit 31 (SOA) absorbs inputted light (off state). When current is inputted, the semiconductor optical amplifier unit 31 bears gain (optical gain against an input signal light) according to inputted current (on state).

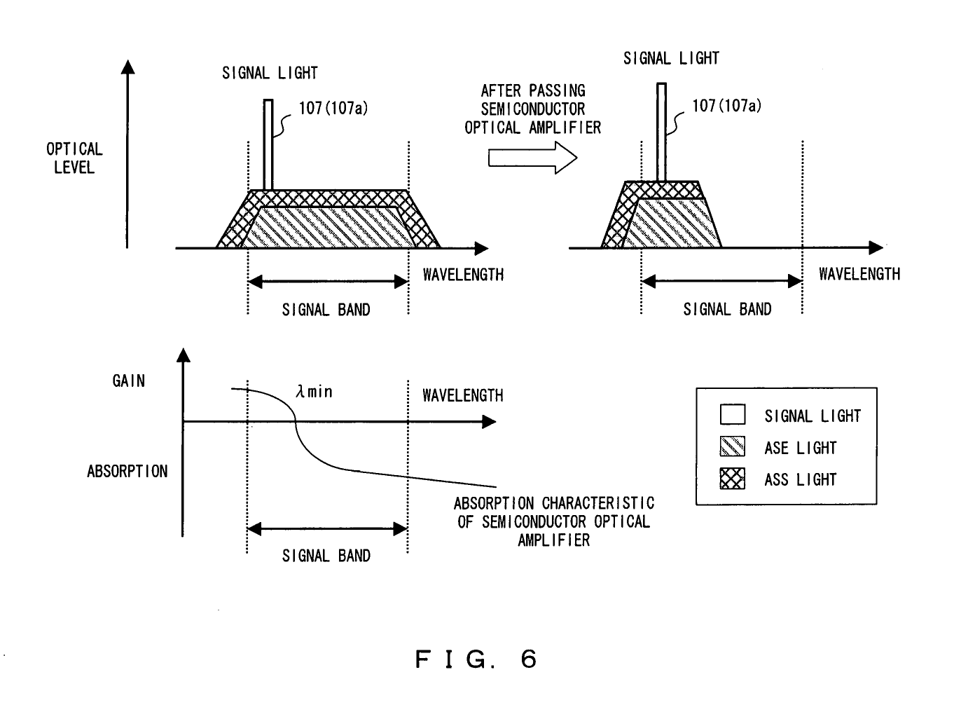

In this case, as shown in FIG. 6, the lower limit 4in of a wavelength range where the absorption characteristic of the semiconductor optical amplifier unit 31 is set in the neighborhood of the long wavelength side of the wavelength range of the partially used wavelength-division multiplex signal light 107 (the optical signal 107a). Therefore, the partially used optical signal 107a is never affected by the absorption characteristic.

As to the control of the amplification/absorption characteristic by input current in the semiconductor optical amplifier, see references, such as “Semiconductor Photonics Engineering” by Ikegami, Tsuchiya and Mikami, pp 442 (Corona Corporation) or” Design and Performance of Monolithic LD Optical Matrix Switches” by S. Oku et al., Photon, Switching' 90, Tech. Dig., 13C-17 (1990) and the like.

Since the semiconductor optical amplification control unit 32 controls the control current 32a, based on wavelength number information (information about the number of actually used wavelengths) from the device control unit 40 so that the semiconductor optical amplifier unit 31 can show a gain/absorption characteristic shown in FIG. 6 in the case of a small number of wavelengths, the optical amplification device 108 with the configuration shown in FIG. 2 reduces noise light components, such as ASS light, ASE light and the like, changes the ratio of signal light to noise light in the case of a small number of wavelengths, and surely monitors the detection of interruption by the optical power monitor unit 15 when a signals is interrupted.

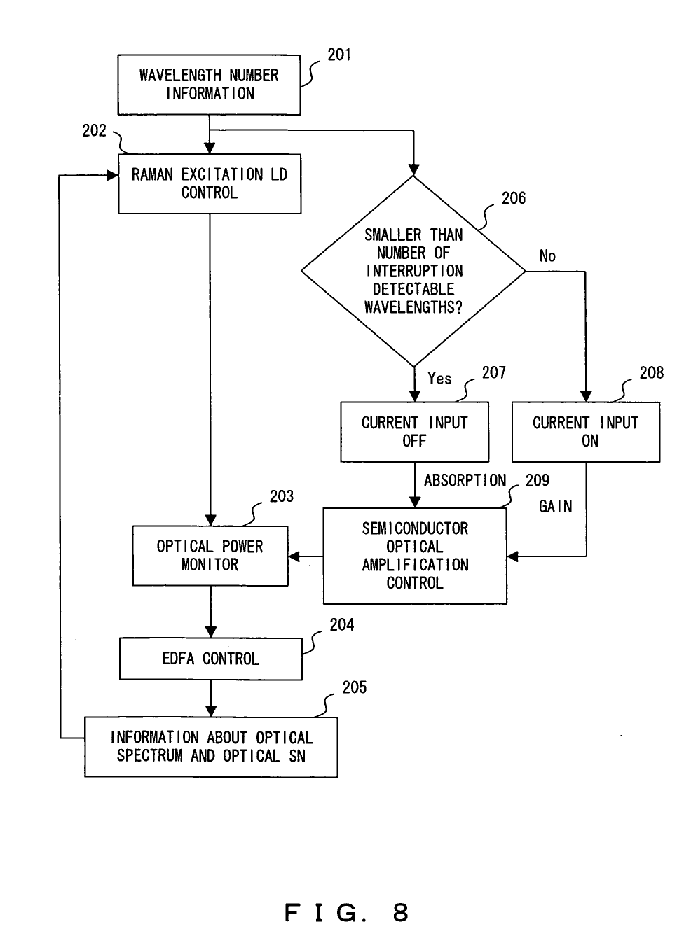

One example of the function of this preferred embodiment is described below with reference to a flowchart shown in FIG. 8 and the like.

Firstly, prior to the operation of the optical wavelength-division multiplex transmission system 100, how many number of ones, of the maximum number (K) of the optical signals 107a that can be used according to the respective mechanical specifications of the optical multiplexer 102 and optical demultiplexer 105 is determined, and this value is set in the device control unit 40 as wavelength number information.

Then, each optical amplification device 108 reads information about the number S of wavelengths from the device control unit 40 (step 201). If the number S of wavelengths is smaller than the interruption detectable number m of wavelengths, the current input of the semiconductor optical amplifier 30 to the semiconductor optical amplifier unit 31 is switched off (step 207), and as shown in FIG. 6, the semiconductor optical amplifier unit 31 is controlled so as to show the absorption characteristic in a band on the longer wavelength side than an optical signal 107a to be used (step 209).

By the control of this semiconductor optical amplifier unit 31, in a wavelength-division multiplex signal light 107 after passing through the semiconductor optical amplifier unit 31, the respective amount of light of ASE and ASS out of a wavelength band for the used optical signal 107a is reduced, and accordingly, the amount of noise light (ASE, ASS) to the optical signal 107a is reduced. Thus, interruption detection can be accurately performed based on the level determination by a threshold value of the amount of the wavelength-division multiplex signal light 107 (sum of the optical signals 107a) in the optical power monitor unit 15.

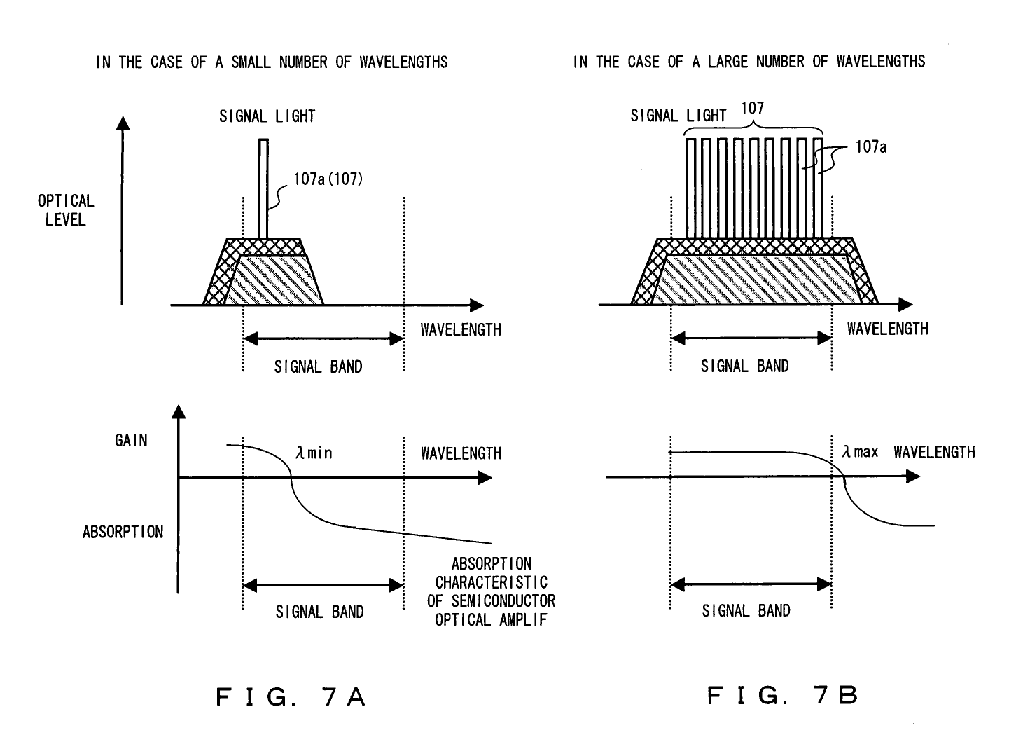

If in step 206, the number S of wavelengths is larger than the interruption detectable number m of wavelengths, the current input of the semiconductor optical amplifier 30 to the semiconductor optical amplifier unit 31 is switched on (step 208), the semiconductor optical amplifier unit 31 is controlled so as to show an amplification characteristic in the case of a large number of wavelengths shown in FIG. 7B. Thus, a plurality of the used optical signals 107a (the wavelength-division multiplex signal light 107) all pass through the semiconductor optical amplifier unit 31, and accordingly, no transmission of the wavelength-division multiplex signal light 107 is hindered.

In parallel with the above-mentioned steps 201, and 206 through 209, each optical amplification device 108 controls the excitation light source 12 for the Raman amplifier 10 (step 202), monitors an optical level by the optical power monitor unit 15 (step 203), and controls amplification by the EDFA unit 20, after exceeding a specific level (step 204).

Each optical amplification device 108 performs tilt control (control for making the signal levels of a plurality of optical signals 107a contained in the wavelength-division multiplex signal light 107 uniform) by controlling to feed back the optical SN information of the optical spectrum analyzer 23 and the like, to the Raman amplification control unit 13, and controlling the excitation light source 12 of the Raman amplifier 10 (step 205).

As described above, according to this preferred embodiment, even when the optical-wavelength-division multiplex transmission system 100 is operated in a state where the number of optical signals 107a is small, the interruption detection of wavelength-division multiplex signal light 107 can be accurately performed in the optical amplification device 108.

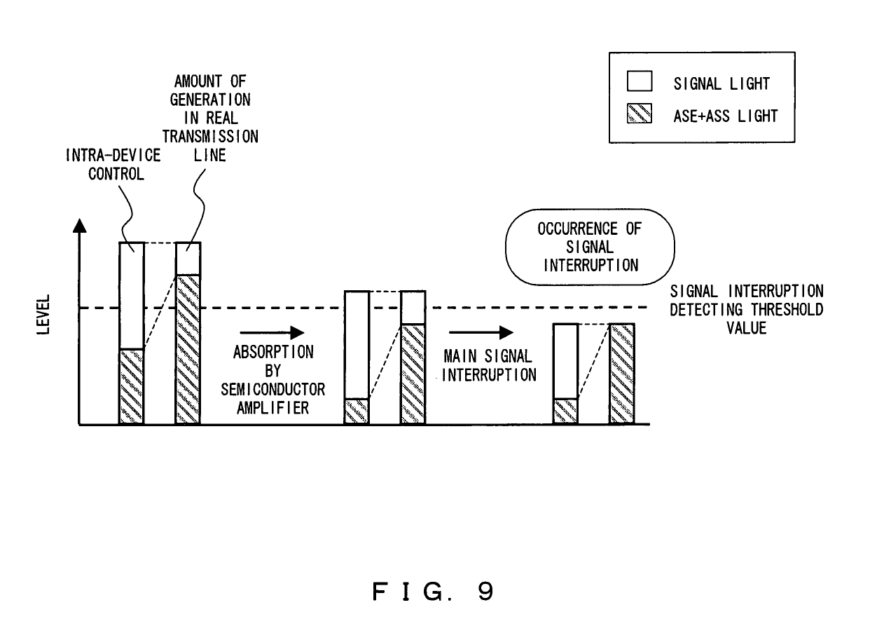

FIG. 9 explains the change of the amount of the wavelength-division multiplex signal light 107 to be monitored by the optical power monitor unit 15. If the amount of noise light, such as ASE and ASS, is reduced by feeding back output information, such as an optical spectrum, an optical SN and the like, from the optical spectrum analyzer 23, to the Raman amplification control unit 13 when no semiconductor optical amplifier 30 of this preferred embodiment is provided in the case of a small number of wavelengths, as shown at the left end of FIG. 9, in the actual transmission line (real transmission line), the amount of the relevant noise light exceeds the threshold value for signal interruption detection, and accordingly, it becomes difficult to accurately detect interruption.

However, if, as shown in the center of FIG. 9, the semiconductor optical amplifier 30 of this preferred embodiment functions to absorb noise light, in the real transmission line, the amount of the relevant noise light never exceeds the threshold value for signal interruption detection. In this case, if, as shown at the right end, the wavelength-division multiplex signal light 107 extinguishes due to the disconnection of the optical transmission line 104 or the like, the level of the wavelength-division multiplex signal light 107 containing noise light surely drops below the signal interruption detection threshold value and interruption detection can be accurately performed by the optical power monitor unit 15.

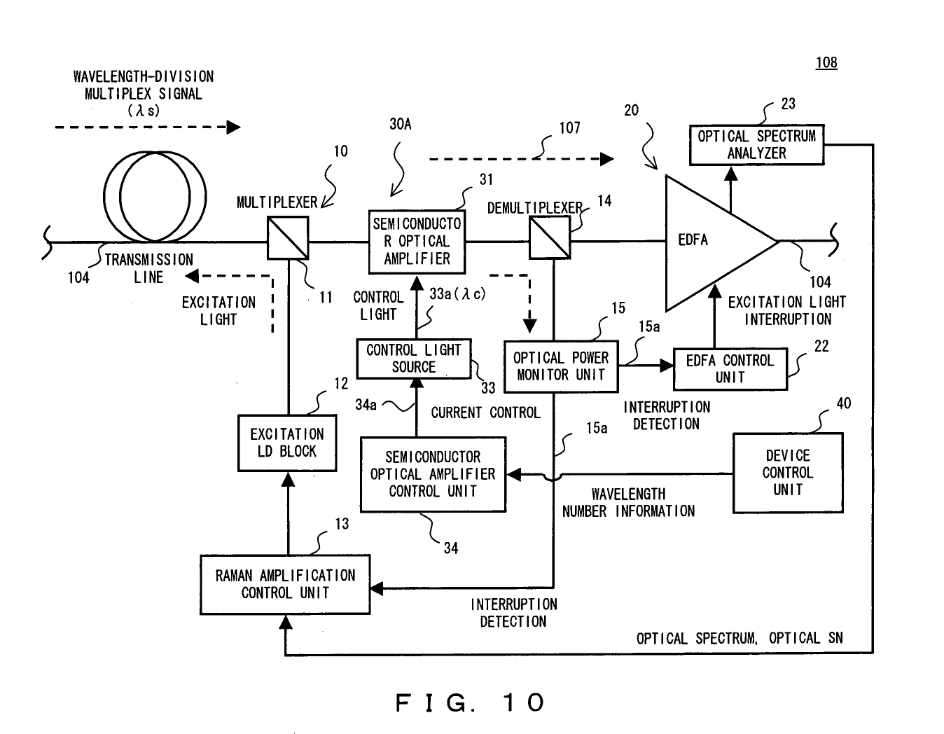

Next, the variations of this preferred embodiment are described. FIG. 10 shows the basic configuration of another optical amplification device of one preferred embodiment.

In the configuration shown in FIG. 10, the semiconductor optical amplifier 30 comprises a semiconductor optical amplifier unit 31, a control light source 33 for inputting control light 33a to this semiconductor optical amplifier unit 31, and a semiconductor optical amplification control unit 34 for controlling this control light source 33. A band for the amplification/absorption of light in the semiconductor optical amplifier unit 31 is controlled by this control light 33a inputted to the semiconductor optical amplifier unit 31 from the control light source 33.

The configuration of the semiconductor optical amplifier unit 31 is the same as in shown in FIG. 4, and the band for the amplification/absorption of light is controlled by inputting control light 33a to an active layer 31a.

Specifically, the refractive index of the active layer 31a of the semiconductor optical amplifier unit 31 depends on carrier density. If light with sufficient intensity is inputted to the semiconductor optical amplifier unit 31 (SOA) to which current is putted in a stationary state, carrier intensity decreases due to carrier re-union. In this case, if light input is stopped, the carrier density increases to restore to the original state. Therefore, by switching on/off the input of light (control light 33a) to the active layer 31a, carrier density can be changed, and accordingly, the refractive index of the semiconductor active layer 31a can be changed.

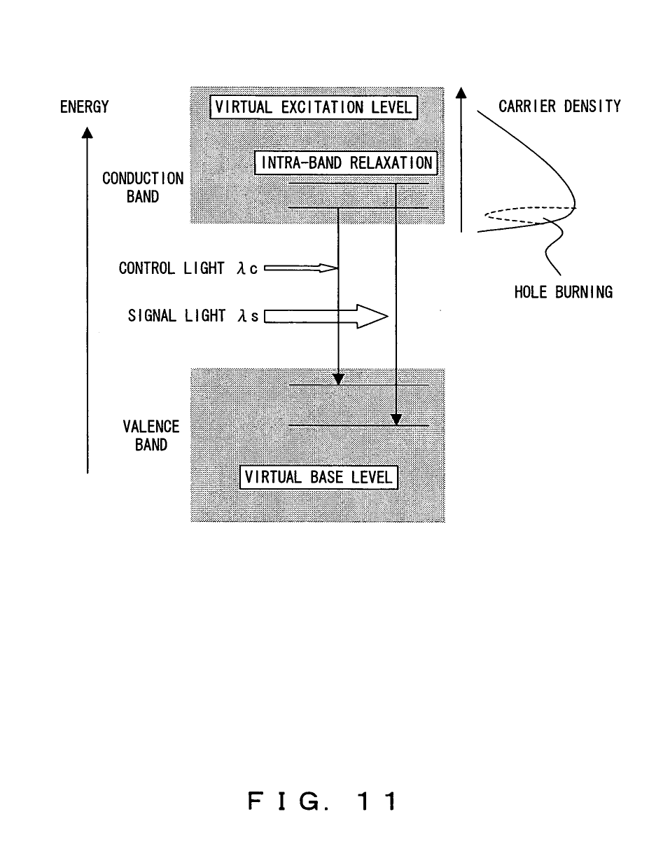

This is described below with reference to FIG. 11. It is assumed that the wavelength of the wavelength-division multiplex signal light 107 and the wavelength of control light 33a are λₛ and λ_{c}, respectively. In this case, if control light 33a with sufficient intensity (λₛ<λ_{c}) is inputted to the semiconductor optical amplifier unit 31, a carrier around the bottom end of a conduction band transits to a balance band due to induced emission. Then, carrier density around the bottom end of the conduction band decreases and hole burning occurs. Since an electron at a conduction band level, including a signal light level, transits to a control light level in order to make up for the hole burning, the gain of the signal light decreases according to the intensity of the control light. As in FIG. 4, for the semiconductor optical amplifier unit 31, which is a semiconductor optical amplification medium, for example, an InGaAsP double hetero type semiconductor laser diode whose mirror function is equivalently eliminated by applying non-reflective coating to the end surface of the laser diode can be used.

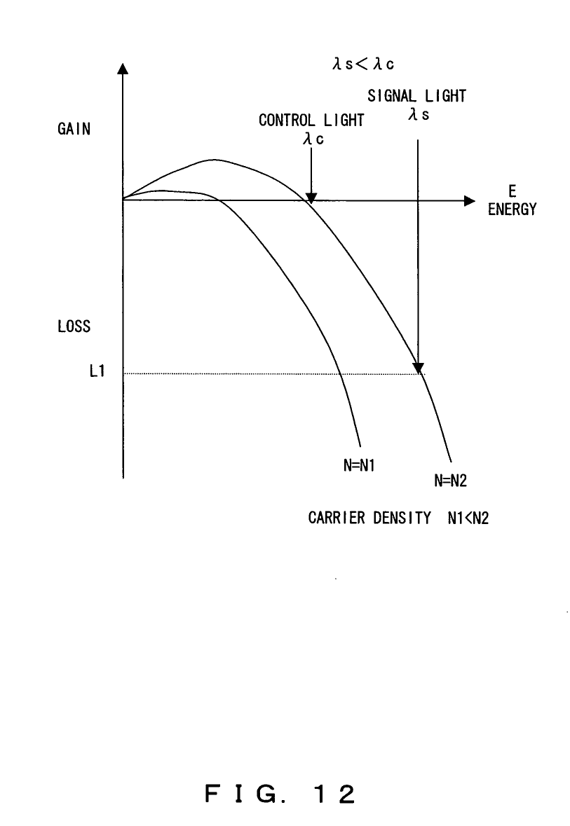

Relationship between the change of a gain spectrum in the semiconductor optical amplifier unit 31 and a gain change in a signal light wavelength is shown in FIG. 12. Each of the respective wavelengths of control light 33a (λ_{c}) and wavelength-division multiplex signal light 107 (λₛ) is determined by the gain spectrum of an amplification medium. The gain spectrum is determined by carrier density N. In the case of low density (N1), the signal light is absorbed and its loss becomes L1.

For the control of a semiconductor optical amplifier by light, see Japanese Patent Laid-open Application No. 7-111528.

In the optical amplification device 108 with the configuration shown in FIG. 10, in the case of a small number of wavelengths (S<m), by controlling light by the control light 33a so that the semiconductor optical amplifier unit 31 can show the gain/absorption characteristic shown in FIG. 6, the semiconductor optical amplification control unit 34 can reduce noise components, such as ASS light, ASE light and the like, change the ratio of signal light to noise light in the case of a small number of wavelengths, and surely monitor interruption detection when the wavelength-division multiplex signal light 107 is interrupted.

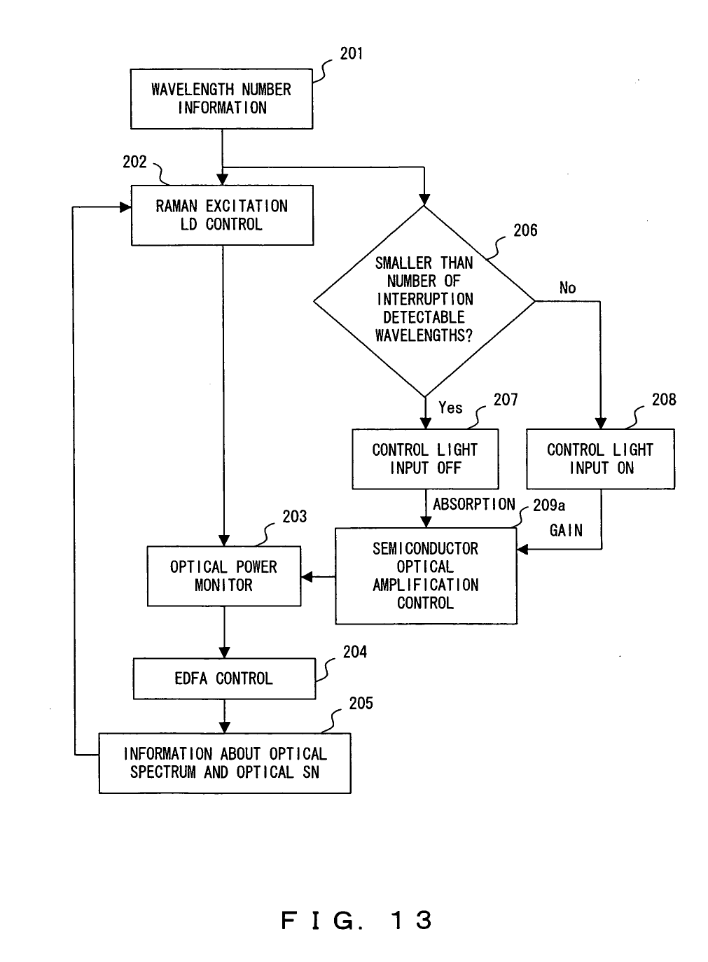

A flowchart showing the operation of the optical amplification device 108 is shown in FIG. 13. The flowchart shown in FIG. 13 is almost similar to the above-mentioned flowchart shown in FIG. 8. The flowchart shown in FIG. 13 differs from the flowchart shown in FIG. 8 only in that the amplification/absorption characteristic of the semiconductor optical amplifier unit 31 is controlled by controlling the control light 33a by the semiconductor optical amplification control unit 34 (step 209a), instead of controlling the amplification/absorption of the semiconductor optical amplification control unit 32 by control current 32a in step 209 of the flowchart shown in FIG. 8.

In this preferred embodiment too, in the case of a small number of wavelengths (S<m), the interruption of the wavelength-division multiplex signal light 107 can be accurately detected by the optical power monitor unit 15 without being affected by noise light, such as ASE, ASS and the like.

Next, another optical amplification device 108 is further described.

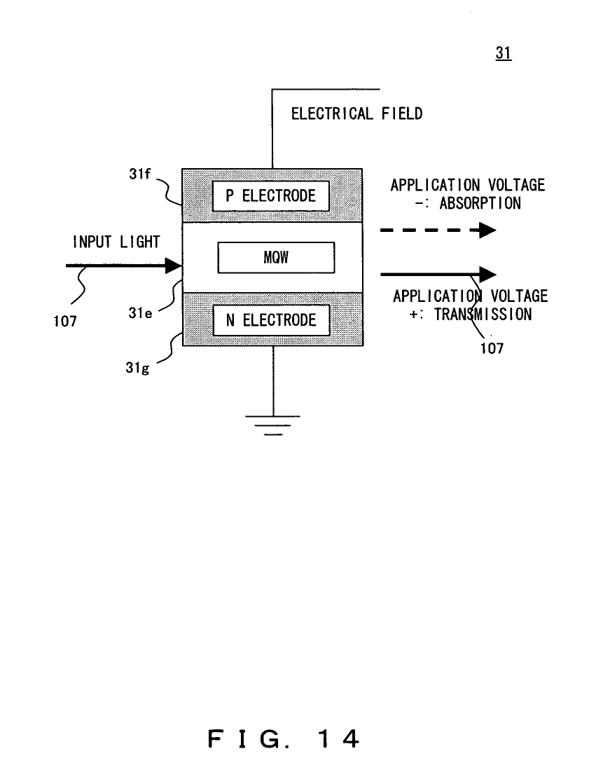

In this variation, for the semiconductor optical amplifier unit 31, a semiconductor optical amplifier unit 31 with a configuration shown in FIG. 14 is used. In this case, the semiconductor optical amplifier unit 31 has a structure in which a semiconductor active layer with a multiplex quantum well (MQW) structure 31e is pinched by a P electrode 31f and an N electrode 31g, and electrical field is applied both to the P electrode 31f and N electrode 31g from the outside.

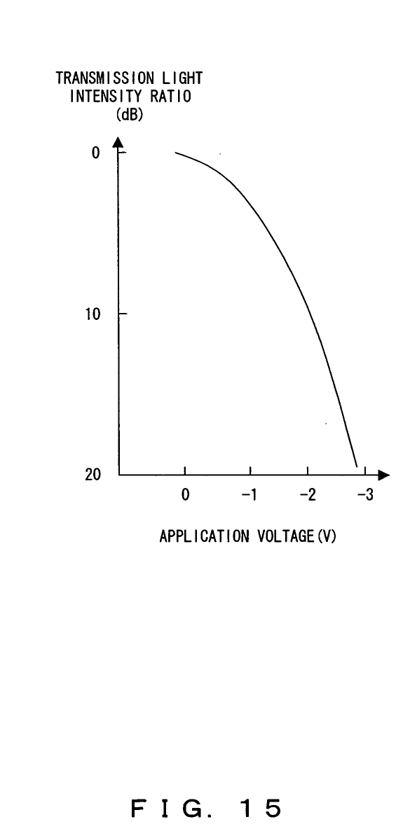

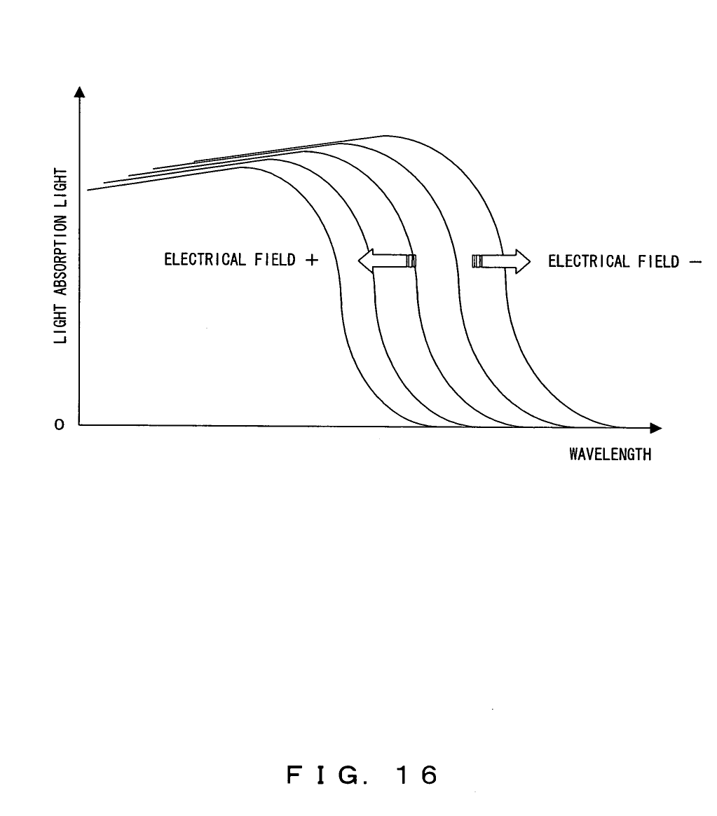

In a semiconductor active layer with a multiplex quantum well (MQW) structure (the multiplex quantum well structure 31e), exciton absorption is observed. When electrical field is vertically applied to the well structure, this absorption peak wavelength shifts to the long wavelength side, in proportion to the square of electrical filed intensity (see FIG. 15), as shown in FIG. 16 (quantum confinement Stalk effect (QCSE)).

Specifically, in a quantum well (QW) semiconductor structure, when electrical field is vertically applied to this thin layer structure, an exciton that is confined to a quantum well remains un-destroyed by a fairly high electrical field, and as a result, the absorption end shits to the long wavelength side in proportion to the square of the electrical field intensity (QCSE). If voltage is applied in one direction when an MQW made of InGaAs/InAlAs is used for the absorption medium (the semiconductor optical amplifier unit 31), input light is absorbed.

For the shift of an absorption wavelength band by the application of electrical field, for example, see the “Semiconductor Photonics Engineering” by Ikegami, Tsuchiya and Mikami, pp. 421 (Corona Corporation).

In the optical amplification device 108 shown in FIG. 2, a multiplex quantum well (MQW) structure 31e shown in FIG. 14 is provided in the active layer of the semiconductor optical amplifier unit 31, and application voltage is controlled by the semiconductor optical amplification control unit 32 instead of the control of control current 32a.

Specifically, in the case of a small number of wavelengths (S<m), electrical field is controlled so that an optical modulation unit composed of MQWs instead of semiconductor optical amplifiers can show the gain/absorption characteristic shown in FIG. 6, based on wavelength number information from the device control unit 40. Thus, noise components, such as ASS light, ASE light and the like, out of a necessary band, included in the wavelength-division multiplex signal light 107 is absorbed and reduced, the ratio of the wavelength-division multiplex signal light 107 to noise light is changed, and the optical power monitor unit 15 surely detects interruption when the wavelength-division multiplex signal light 107 is interrupted.

In order to obtain the same effect, an InGaAs/InP semiconductor using Franz-Keldish (FK) effect can also be used instead of a QCSE.

As shown in FIG. 16, a semiconductor optical amplifier unit 31 (Optical modulator) using a MQW has wavelength dependence on light absorption current. Using this characteristic, in the configuration shown in FIG. 14, as shown in FIG. 7A, electrical field can also be controlled so that in the case of a small number of wavelengths (S<m), the semiconductor optical amplifier can show an absorption characteristic at λₘᵢₙ and in the case of a large number of wavelengths (S≧m) it can show an amplification characteristic in a signal wavelength area.

Specifically, in the case of a small number of wavelengths as shown in FIG. 7, the electrical field is controlled so that application electrical field can be made large on the (+) side, be shifted to the short wavelength side and λₘᵢₙ is located in the external neighborhood of a band for a small number of the optical signals 107a. Then, noise components, such as ASS light, ASE light and the like, out of a necessary band, included in wavelength-division multiplex signal light 107 can be absorbed and reduced. Then, the ratio of the wavelength-division multiplex signal light 107 to the noise light can be changed, and the optical power monitor unit 15 can surely detect interruption when the wavelength-division multiplex signal light 107 is interrupted.

If a large number of the optical signals 107a are used (S≧m), as shown in FIG. 7B, the application electrical field is made large on the (−) side of the multiplex quantum well (MQW) structure 31e, an absorption band is shifted to the long wavelength side, and is controlled so that the entire band of the wavelength-division multiplex signal light 107 can enter the gain area of the multiplex quantum well (MQW) structure 31e.

As described above, according to the preferred embodiment of the present invention, even in the case of a small number of wavelengths, signal interruption can be detected, and automatic power shutdown can be surely performed. There becomes no need for the conventional ASE correction control that has been performed to improve an optical SN degradation due to the large ratio of the wavelength-division multiplex signal light 107 to ASE light in the case of a small number of wavelengths (S<m), and accordingly, the speed of the startup of devices, such as the optical wavelength-division multiplex transmission system 100, the optical amplification device 108 and the like, can be improved. Conversely, in the case of a large number of wavelengths (S≧m), longer distance transmission can be possible by restricting electrical field to the essential amplification characteristic area of the semiconductor optical amplifier 30.

The present invention is not limited to the above-mentioned preferred embodiments, and variations and modifications are also possible as long as the subject matter of the present invention is not deviated.

According to the present invention, in the optical transmission line for wavelength-division multiplex communication, the interruption of signal light can be accurately detected without being affected by the increase/decrease of the number of wavelengths to be used.

A variety of control can also be precisely performed based on the level determination of signal light, using a prescribed threshold value or the like.

What is claimed is:

1. An optical amplification device which is disposed in an optical transmission line for transmitting a plurality of segments of signal light each with a different wavelength, comprising:
a first optical amplifier disposed in the optical transmission line;
an optical power monitor unit provided in the down stream of the first optical amplifier in order to control the first optical amplifier; and
a second optical amplifier capable of variably controlling the amplification band and absorption band of light.

2. The optical amplification device according to claim 1, wherein
said first optical amplifier is a Raman amplifier for amplifying the signal light by inputting excitation light in the optical transmission line, and
said second optical amplifier is a semiconductor optical amplifier, and
the absorption characteristic area of said semiconductor optical amplifier is set so that the passage of light out of the band used for the signal light, of the plurality of segments of signal light each with a different wavelength is restricted according to the increase/decrease of the number of the used signal light.

3. The optical amplification device according to claim 1, further comprising in the down stream of said optical power monitor unit in the optical transmission line
a third optical amplifier for amplifying the signal light, wherein
said optical power monitor unit controls said third optical amplifier.

4. A Raman amplifier which is disposed in an optical transmission line for transmitting a plurality of segments of signal light each with a different wavelength, comprising between a multiplexing unit for inputting excitation light in the optical transmission line and an optical power monitor unit provided in the down stream of the multiplexing unit for controlling the Raman amplifier
a semiconductor optical amplifier.

5. The Raman amplifier according to claim 4, wherein
the absorption characteristic area of said semiconductor optical amplifier is set out of a band for the signal light to be used, of the plurality of segments of signal light each with a different wavelength.

6. The Raman amplifier according to claim 4, wherein
the absorption characteristic area of said semiconductor optical amplifier is set out of a band for the signal light to be used by controlling current applied to said semiconductor optical amplifier.

7. The Raman amplifier according to claim 4, wherein
the absorption characteristic area of said semiconductor optical amplifier is set out of a band for the signal light to be used by applying control current to said semiconductor optical amplifier.

8. The Raman amplifier according to claim 4, wherein
said semiconductor optical amplifier comprises an active layer with a multiplex quantum well structure, and
the light absorption coefficient of said active layer is controlled by controlling electrical field to be applied to said active layer, and the absorption characteristic area of said semiconductor optical amplifier is set out of a band for the signal light to be used by controlling the light absorption coefficient of said active layer.

9. An optical wavelength-division multiplex transmission system, comprising:
an optical transmission line for transmitting signal light;
a multiplexer for integrating the plurality of segments of signal light each with a different wavelength and transmitting the signal light to the optical transmission line;
a demultiplexer for branching and extracting the plurality of segments of signal light each with a different wavelength from the optical transmission line; and
an optical amplification device, provided in the optical transmission line, for amplifying the signal light,
said optical amplification device, comprising:
a first optical amplifier disposed in the optical transmission line;
an optical power monitor unit provided in the down stream of the first optical amplifier in order to control the first optical amplifier; and
a second optical amplifier capable of variably controlling the amplification band and absorption band of light.

10. The optical wavelength-division multiplex transmission system, according to claim 9, wherein
said first optical amplifier is a Raman amplifier,
said second optical amplifier is a semiconductor optical amplifier, and
the absorption characteristic area of said semiconductor optical amplifier is set in such a way as to restrict the passage of light out of the band for the signal light to be used, of the plurality of segments of signal light each with a different wavelength, by controlling current, light or electrical field to be applied to the active layer of said semiconductor optical amplifier.

11. An optical wavelength-division multiplex transmission method for disposing a Raman amplifier in an optical transmission line for transmitting a plurality of segments of signal light each with a different wavelength, comprising:
disposing a semiconductor optical amplifier between a multiplexing unit for inputting Raman excitation light to the optical transmission line and an optical power monitor unit and absorbing light out of a band for the signal light to be used by said semiconductor optical amplifier, according to the increase/decrease of the number of the signal light to be used.

12. The optical wavelength-division multiplex transmission method according to claim 11, wherein
current to be applied to said semiconductor optical amplifier is controlled so that the absorption characteristic area of said semiconductor optical amplifier can be set out of the band for the signal light, according to the increase/decrease of the signal light to be used.

13. The optical wavelength-division multiplex transmission method according to claim 11, wherein
control light to be applied to said semiconductor optical amplifier is controlled so that the absorption characteristic area of said semiconductor optical amplifier can be set out of the band for the signal light, according to the increase/decrease of the signal light to be used.

14. The optical wavelength-division multiplex transmission method according to claim 11, wherein
said semiconductor optical amplifier comprises an active layer with a multiplex quantum well (MQW) structure, and
the light absorption co-efficient of said active layer is controlled so that the absorption characteristic area of said semiconductor optical amplifier can be set out of the band for the signal light, according to the increase/decrease of the signal light to be used, by controlling electrical field to be applied to said active layer.

15. A Raman amplifier wherein
a semiconductor optical amplifier is disposed between a multiplexing unit for inputting Raman excitation light to an optical transmission line for transmitting a plurality of segments of signal light, and an optical power monitor unit and a rare earth-doped optical fiber amplifier.

16. The Raman amplifier according to claim 15, wherein
the respective amount of amplified spontaneous emission (ASE) and amplified spontaneous Raman scattering (ASS) is reduced by controlling current to be applied to said semiconductor optical amplifier so that the absorption characteristic area of said semiconductor optical amplifier can be set out of a band for the signal light, according to the increase/decrease of the signal light to be used, and the detection of the signal light is surely detected.

17. The Raman amplifier according to claim 15, wherein
the respective amount of amplified spontaneous emission (ASE) and amplified spontaneous Raman scattering (ASS) is reduced by controlling control light to be applied to said semiconductor optical amplifier so that the absorption characteristic area of said semiconductor optical amplifier can be set out of a band for the signal light, according to the increase/decrease of the signal light to be used, and the detection of the signal light is surely detected.

18. The Raman amplifier according to claim 15, wherein
said semiconductor optical amplifier comprises an active layer with a multiplex quantum well (MQW) structure, and
the respective amount of ASE and ASS is reduced by controlling electrical field to be applied to the active layer and then the light absorption co-efficient of the active layer so that the absorption characteristic area of said semiconductor optical amplifier can be set out of a band for the signal light, according to the increase/decrease of the signal light to be used, and the interruption of the signal light is surely detected.

19. The Raman amplifier according to claim 15, wherein
said semiconductor optical amplifier comprises an active layer with a multiplex quantum well (MQW) structure, and
said active layer controls electrical field so as to show an absorption characteristic at λₘᵢₙ in the external neighborhood of the long wavelength end of the wavelength band of the plurality of segments of signal light, and absorbs and amplifies an arbitrary wavelength.
